(19) United States
(12) Patent Application Publication
(10) Pub. No.: US 2003/0220891 A1
(43) Pub. Date: Nov. 27, 2003

(54) Matter management computer software

(76) Inventor: Robert D Fish, La Habra, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/009,014

(22) PCT Filed: Dec. 22, 2000
(86) PCT No.: PCT/US00/35133

(51) Int. Cl. G06F 17/30

(52) U.S. Cl. 707/1

(57) ABSTRACT

A matter management software is improved through the use of management improvement features selected from (a) a single display (100) that shows matter identification information (130A-G), a plurality of miulestones (150), a plurality of hourly billing descriptions (160), and a plurality of calendared items (170); (b) a user-defined on-line procedures mechanism accessed by selection of a milestone of the plurality of milestones; (c) a matter specific timer based reminder mechanism (186); and (d) a plurality of identifier/value pairs for storing data. In another aspect identifier/value pairs can be used to stole including data for milestones, office procedures, matter details, contact relationships, and contact specific or address specific information.

### FIELD OF THE INVENTION

The field of the invention is matter management computer software, such as may be used by attorneys and law firms to maintain control of their client matters.

### BACKGROUND OF THE INVENTION

There have been numerous improvements in matter management software over the years, as exemplified by software such as Timeslips™, QuickBooks™ and CTS™ by FlexTrac Systems, Inc., Dimension™ by Computrac, Inc. and Junior Partner™ for Windows™ by Millenium Software Ltd. Among other things, sophisticated timekeeping and billing software packages have been ported from mainframe computers to desktop and laptop computers, and redesigned to make greater use of graphical user interfaces (GUI interfaces). Despite the many advances, however, it turns out that existing matter management software packages still lack several features that would greatly increase their usefulness.

Overview Sheet

One particularly pressing need is for a more convenient overview of the status of a matter. Some of the existing packages display basic matter identification information such as matter title, client name and so forth, using an interface that also displays a few milestones and a few calendared events. It is also known to display identification information in an interface that includes individual hourly billing descriptions. But there appears to be no packages that display identification information, the plurality of milestones, the plurality of hourly billing descriptions, and the plurality of calendared items in the same display.

On-Line Office Procedure Manual

A related need is for an on-line office procedure manual that can be tied into the milestones. The need is particularly acute in an office worker that would normally handle a task is not available, such as may be caused by employee turnover, or by an employee taking vacation time. A very simple example illustrates the point. In known systems for patent law firms, receipt of an office action from the patent office may trigger the automatic calendaring of the drafting of a response to the office action. But a new employee may not know that in addition to calendaring the response, a copy of the office action should be forwarded to the client, the inventors, and the responsible attorney. Similarly, the filing of a new patent application may trigger automatic calendaring of a reminder to check the file for a filing receipt, but a new employee may not know that along with filing of a new application, one should include related documents such as a Small Entity Statement, A Declaration And Power Of Attorney, an Information Disclosure Statement, a 1449 form, a check to cover the filing fee, and a postcard. Of course, many offices have checklists for such items, and possibly even an employee manual with reminder lists. But such lists are of decidedly reduced usefulness because they are not automatically accessed upon the recording of the triggering event.

Non-Calendar Reminder Mechanism

Yet another problem with existing timekeeping and billing systems is that users of such systems, whether secretaries, paralegals, attorneys or others, often have considerable difficulty properly calendaring events into the future. Where matters involve calendaring litigation, for example, calendaring rules differ from court to court, and possibly even case to case, and it is difficult or impossible for any given individual to maintain knowledge of all such rules. The situation is greatly exacerbated in intellectual property law because events are often calendared many years in advance. To some extent this problem has been addressed by auto-calendaring routines that calendar events based upon user modifiable rules sets. But even auto-calendaring routines are only effective in helping to avoid mis-calendaring. They offer no help at all in preventing non-calendaring errors, such as may result from lost or misplaced mail.

In a patent law office, for example, it often happens that an attorney will submit a paper to the patent office, and not receive any sort of response for a year, or even longer. Because of the lengthy time delay, and because the patent office can be expected to issue an office action at some point in time, many attorneys will not calendar any follow-up until they receive a first office action. That tactic is, of course, problematic since an application or office action may get lost in the mail, or even within the attorney's own office. In such instances the application may well go abandoned. Even if the attorney has an internal policy to calendar follow-ups for lengthy periods of time such as 6 and 12 months, such calendaring still requires an affirmative step, and is therefore still subject to human error. Failure to take a necessary affirmative step will still allow the application to go abandoned. Thus, there is a continuing need to provide a reminder mechanism that operates independently of the calendaring system. If the reminder mechanism were somehow triggered by entries of milestones, the user would have the best of both worlds—a reminder system that is independent of calendaring, but one that could still be reset automatically during the ordinary course of business. Such a mechanism, however, is unknown in the field.

User-Defined Data Fields

Several existing systems provide generic data fields that users can adapt for their own custom purposes. Such users may, for example, use the generic fields to store dates, serial numbers, inventor names, and so forth. One continuing problem, however, is that in known systems this flexibility is only available on a global or matter type level, not on the level of individual matters. Designating that generic field number 4 is to be used for a serial number is a complete waste of space for matters that don't use serial numbers. The same would be true about storing a client's status as a large or small entity. The information is relevant to US patent filings, but is irrelevant for most foreign patent filings, and is certainly irrelevant for copyright filings. Not only does designation of a generic field as a specialty field waste disk space, it also wastes real estate on the interface (computer display), and renders the interface more confusing than it needs to be. Thus, there is a continuing need to store information in a timekeeping/billing system according to user-defined fields that can vary on a matter-by-matter basis.

Another problem with existing user-customizable fields is that the custom fields are hard to keep track of. For example, a user may know that he or she is storing a patentability search date in a particular custom field, but the interface only displays a cryptic filed name such as CFI (perhaps as a designation for customer field number 1). As a result, other users may store corresponding information in some other custom field, and/or may store other types of information in the field being used for search date. In this and other ways the presently available user-customizable fields leave a lot to be desired.

Still another problem with existing user-customizable fields is that such fields are not tied into auto-calendaring or other functions of the system. Yes, it may be possible to print out data stored in custom fields when printing an entire record, but the data is merely stored for retrieval using the display screen, or some sort of report writer. It is not known to the present inventor to interactively search and sort data in user-customizable fields.

Thus, there remains a considerable need for improved matter management software and related methods.

### SUMMARY OF THE INVENTION

The present invention provides timekeeping software having at least one of several improvements. One improvement is a single display that shows matter identification information, the plurality of milestones, the plurality of hourly billing descriptions, and the plurality of calendared items. Another improvement is a user-defined on-line procedures mechanism, which is preferably tied into the milestones. Still another improvement is a matter specific timer based reminder mechanism, such as a count-down or count-up timer. Still another improvement is the use of user-defined fields at the matter level, preferably using a plurality of identifier/value pairs (see “Identifier/Value Concept” infra). The software may advantageously display a field description in conjunction with each piece of data displayed, and provide a drop down listing of field descriptions for selection by the user.

Especially preferred embodiments include several of these improvements. For example, the milestones may advantageously comprise custom fields that can be selected on a matter-by-matter basis. As another example, selection of user-defined milestones may advantageously trigger at least one of autocalendaring, on-line procedure manual, and non-calendar reminder mechanism features.

In another respect the invention provides a method of managing information in a computer implemented matter management system, comprising: storing a plurality of user-defined data identifiers on a database; providing a user interface with a scrollable listing of the identifiers; selecting a subset of the data identifiers for a particular matter; entering and associating an item of text data with at least one data identifier of the selected subset; and interactively displaying in a single display a plurality of identification information data items for the matter, the at least one data identifier, and its associated text data. The data identifiers may be any one or more of milestones, office procedures, matter details, contact relationships, and contact specific or address specific information.

The term “user interface” means a display of data that a nonprogrammer or layperson can access, understand, and operate. A user interface does not include a Microsoft™ Access™ or other data table design interface used programmers to set up data tables, field names, and so forth.

In another respect the invention provides a matter management system that is at least partially stored on a computer readable medium, and comprises a first designation interface that provides for designation of a matter as having a matter type selected from a plurality of matter types; a second designation interface that provides for designation of a plurality of milestones for the matter type; a selection interface that provides for selection of a proper subset of the plurality of milestones as being appropriate for the matter, thereby defining a non-null subset of non-selected members of the plurality of milestones; an interactive display that displays in a single display a plurality of identification information data items for the matter, and at least one of the selected subsets of milestones without listing all of the non-selected members. The system preferably displays all of the selected subsets of milestones and none of the non-selected milestones.

In another respect the invention provides a matter management system having both an auto-calendaring function and a matter timer.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1a is an image of an interface that shows matter identification information, a plurality of milestones, a plurality of hourly billing descriptions, and a plurality of calendared events all on the same display.

FIG. 1b is another image of the user interface of FIG. 1, further depicting a drop down menu for selecting a milestone.

FIG. 2 is an interface for associating milestones with matter types.

FIG. 3 is a matter report showing milestones for multiple matters.

FIG. 4 is an image of an interface that shows a user-defined auto-calendaring mechanism accessed by selection of a milestone.

FIG. 5 is an image of an interface that shows a user-defined on-line procedures mechanism accessed by selection of a milestone.

FIG. 6 is a preferred interface for setting matter specific timers.

FIG. 7 is a sample matter specific timer report.

FIG. 8 is an image of a preferred matter details interface showing matter specific data and contacts, both using identifier/value pairs.

FIG. 9 is an image of a preferred contacts interface showing contact-specific data and address-specific data, both using identifier/value pairs.

FIG. 10 is a matter report depicting a preferred arrangement of milestone, matter detail, and matter contacts stored as identifier/value pairs.

FIG. 11 is an image of an interface for creating records for new matters in the database, and correlating matter type and other information with the matters.

FIG. 12 is an image of a document creation interface.

FIG. 13a is a representation of a previous system of information storage.

FIG. 13b is a representation of information storage having identifier/values.

### DETAILED DESCRIPTION

The various Figures in this application are all part of a matter management software system that is at least partially stored on a computer readable medium. The computer readable medium may be a data disk, tape, a CD ROM or other read only memory, a re-writable CD, a chip based or other random access memory (RAM), or any other suitable medium. The system is most likely implemented on a desktop, laptop, handheld, or other personal computer (PC), although it is also contemplated that one or more components can be stored and/or implemented on multiple computers, including local area and wide area computer networks, application service providers (ASPs), and so forth.

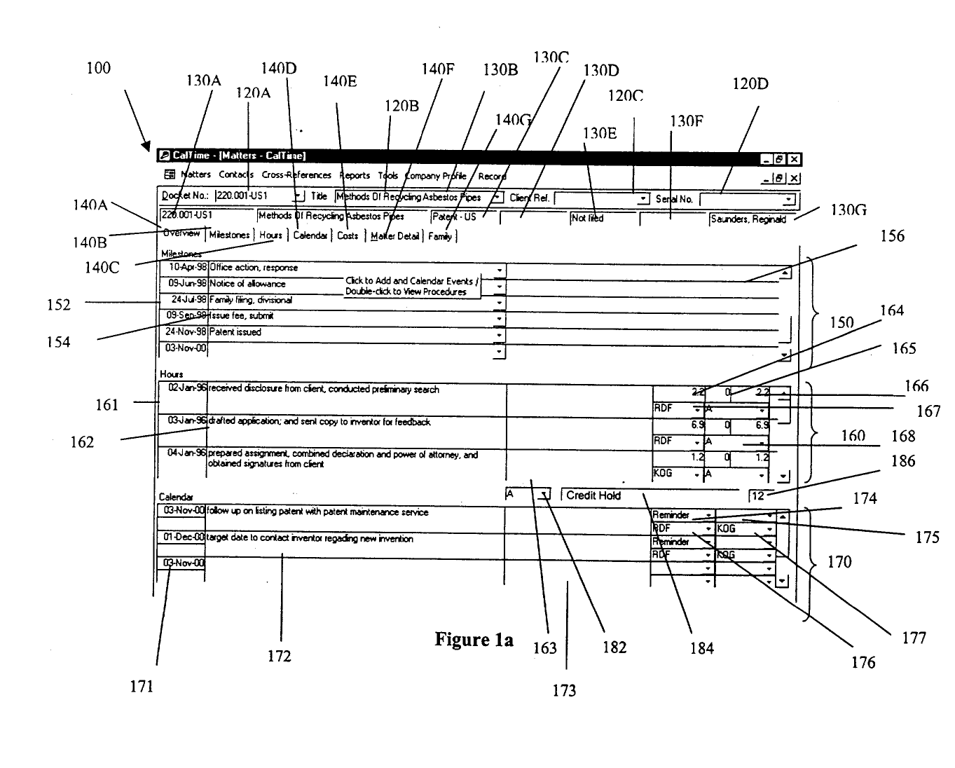

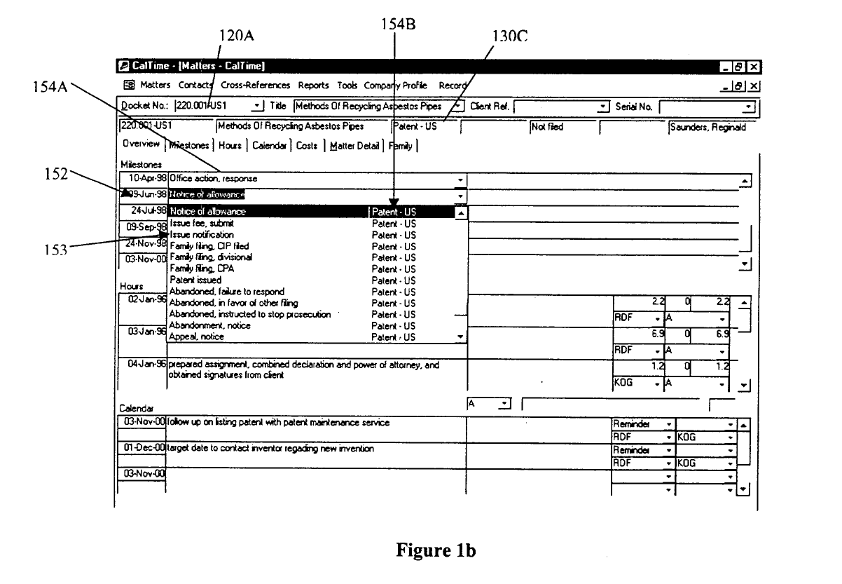

In FIG. 1a a preferred user interface 100 (i.e., a display screen) has record selection areas 120A through 120D, record identifiers 130A-130G, control tabs 140A-140G, milestones section 150, hours section 160, calendar section 170, default rate code field 182, flag field 184, and timer field 186.

The user interface depicted in FIG. 1a is an example of a single display that simultaneously shows matter identification information, at least three of the plurality of milestones, at least three of the plurality of hourly billing descriptions, and at least three of the plurality of calendared items. The matter identification information is displayed in the record identifiers area 130A-130G; milestones are displayed in the milestones section 150; hourly billing descriptions are displayed in the hours section 160; calendared items are displayed in the calendar section 170.

Record Selectors and Identifiers

As will be especially appreciated by those familiar with Microsoft™ products, the record selection areas 120A through 120D accept user input in the selection of a matter record. The term “user” is employed herein to mean an ordinary employee, one having little or no programming skills. Here, selection area 120A provides record selection by docket or matter number, selection area 120B provides record selection by matter name, selection area 120C provides record selection by client reference number, and selection area 120D provides record selection by official serial number. Data can he entered directly into the boxes shown, or by selecting an item from a drop-down list (see FIG. 1b).

Also in this example, selected matter identifiers 130A-130G display information for a selected matter. Identifier 130A displays the docket number, identifier 130B displays the matter title, identifier 130C displays the matter type (patent, trademark, copyright, immigration, state court litigation, contract drafting, opinion letters, etc.), identifier 130D displays the official serial number, identifier 130E displays the status, identifier 130F displays the client's reference number, and identifier 130G displays the client's name. Of course, other record selection and record identifiers could be added to or substituted for those displayed in this example.

Milestones

The Milestones section 150 of FIG. 1a includes multiple rows of data, each row corresponding to one milestone, and each row having data in three columns. The Milestone Date column 152 displays a date corresponding to the milestone on the same row. The default date is usually set to the current date, and in any event the date is preferably restricted to past or present dates since milestones are presumably events that have already occurred. Double clicking on any of the date fields in Milestone Date column 152 preferably displays a miniature monthly calendar (not shown) that assists the user in selecting a date.

The Milestone Description column 154 displays a predefined milestone that is preferably selected from a drop-down type listing such as that depicted in FIG. 1b. The Milestone Comment column 156 displays textual comments that a user may want to associate with a particular milestone. We have found it particularly useful to include a milestone named “comments”, and then to store the text for the comment in the Milestone Comment column 156.

There are several significant advantages to a display such as that of Milestone Section 150. One advantage is that tie interface 100 for a given matter need only list those milestones that are actually being used for that particular matter. If only two milestones have occurred, only two milestones are listed. If thirty milestones have occurred, all thirty are listed (using a vertical slider). This scheme makes excellent use of the real estate on a given display screen. Another advantage is that the milestones listed as being available for use in conjunction with a given matter can be restricted according to the matter type. A patent application matter, for example, has very different milestones from a copyright matter, and certainly from a federal district court litigation matter. Users therefore have for selection all the milestones that are appropriate for a given matter, without being confused by having to view milestones that are not even appropriate.

FIG. 1b is identical to FIG. 1, except that it shows a scrollable drop-down list 153 of milestones appropriate for the matter type 130C of the currently selected matter 120A. As exemplified herein, the drop-down list 153 may comprise a “combo box” in that it shows multiple items of data on each row. In this instance the drop down list showing milestone choices 154A, and associated matter type 154B.

Although not explicitly shown in the figures, every field having a finite number of choices throughout the system may advantageously have a similar style of drop-down list 153, although lists for other fields would be modified in content according to the particular purpose of each field.

Milestones are preferably stored in identifier/value pair format. This format allows users to define their own milestones to cover the various stages of the types of matters that they use. Intellectual property law offices, for example, may advantageously employ several hundred milestones to describe various aspects of intellectual property prosecution, litigation, and so forth. Since any given matter likely only employs five to ten milestones, this technique avoids the great waste of database capacity and display real estate that would otherwise be utilized in hard coding hundreds of milestone fields for each matter. Identifier/value pairs are also advantageous in that they can readily be displayed in pair format, in scrollable windows.

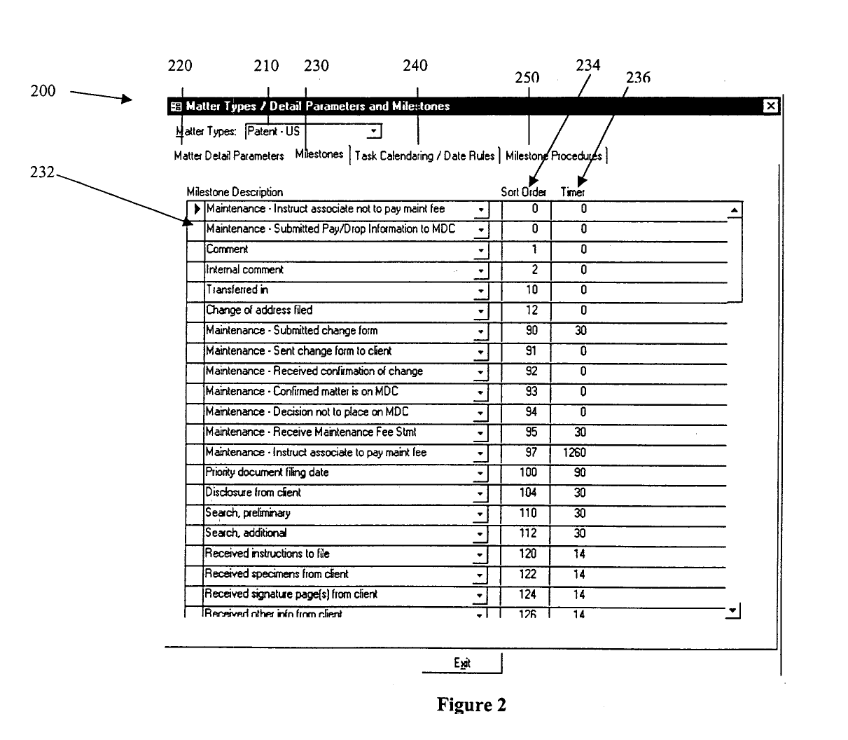

In FIG. 2 a user interface 200 generally includes a matter type selector 210, and tabs for controlling operation of the system with respect to Matter Detail Parameters 220, Milestones 230, Task Calendaring/Date Rules 240, and Milestone Procedures 250. Interface 200 is preferably accessed using a right mouse click in the Milestones Section 150 of FIG. 1. The Milestones tab 230 has three columns, Milestone Description 232, Sort Order 234, and Timer 236.

The user may associate a plurality of milestones 232 with the matter type 210. Once the user has associated the milestones 232, entry of a milestone consists of simply choosing a milestone from the drop down list 153 of FIG. 1b. Sort Order 234 is the typical order of the milestones 232 within the matter type 210. Timer 236 represents the default for the number of days until the matter should be reviewed. For example, entry of a milestone with a 14 day timer tells the user to refer to this matter in 14 days.

Milestone information is thus stored as identifier/value pairs, where both the identifier and the values are user-defined. In preferred such methods, a plurality of user-defined milestone identifiers are stored on a database, (see FIG. 1c), and a user is provided with an interface providing a scrollable listing of the identifiers (see FIG. 1b). Sample identifiers include application drafted, application filed, assignment, foreign filing license, issue fee paid, notice of allowance, office action, matter abandoned, patent issued, and response to office action.

A user then associates a matter with a subset of the milestone identifiers (by selecting a milestone identifier from the list of FIG 1b), and enters a date 152 into the database corresponding to the milestone identifier 154A. The process can be repeated for a subset of identifiers. In most instances the data associated with a milestone identifier will be a date, but the data may also be a comment of some sort, such as “in favor or CIP”, or “patent no. xxxxxxx”. In more preferred embodiments a user may also enter data associating a set of instructions with a selected one of the identifiers, allowing the system to display the instructions upon user selection of the identifier.

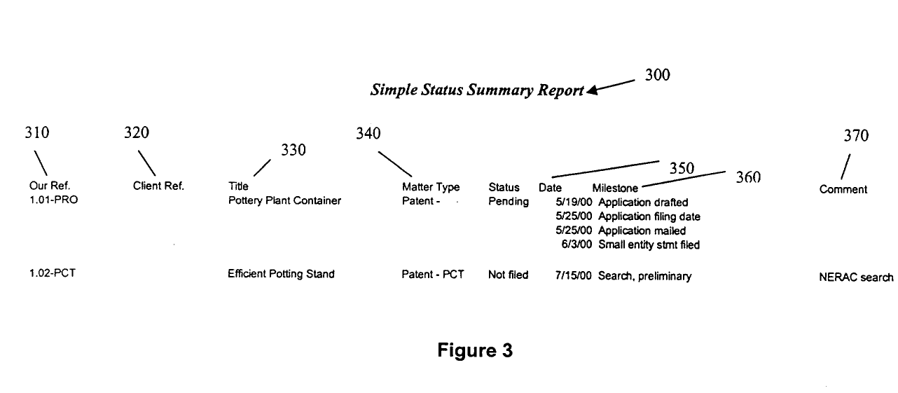

One advantage of the present identifier/value method of storing milestone information is that the system is readily adapted to producing a spreadsheet or word processor based report containing milestone information. In FIG. 3 an exemplary report 300 depicts the following information: docket numbers 310, client reference numbers 320, matter titles 330, matter types 340, milestones 360 with associated dates 350, and comments 370. The report is an example of a user-generated report that displays milestone and other related information for client matters. The use of the comments 370 field is of note as it is an example of an identifier/value/value method.

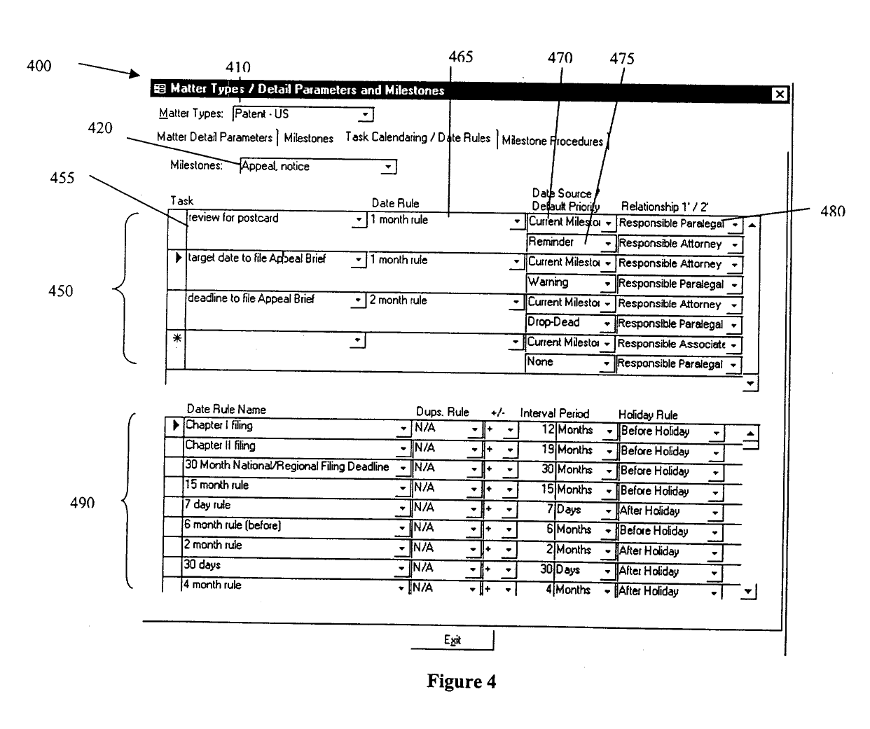

In FIG. 4 an interface 400 displays and accepts task information 450 that is typically calendared for a matter type 410/milestone 420 combination. The task information 450 shows how a preferred system may calendar a task 455 based on a date rule 465. The interface also contains the table of date rule logic 490 that is used by the system when calendaring the tasks. In a preferred embodiment the auto-calendaring information may include the date source 470. For example, a date source 470 of “current milestone” with a “1 month rule” may inform the system to calendar the task 1 month from entry of the milestone 420. The default priority 475 is used to display a priority such as reminder or warning that is associated with the task. Relationship 480 may also be associated to the task. Relationship 480 may be the title of the person responsible for the task.

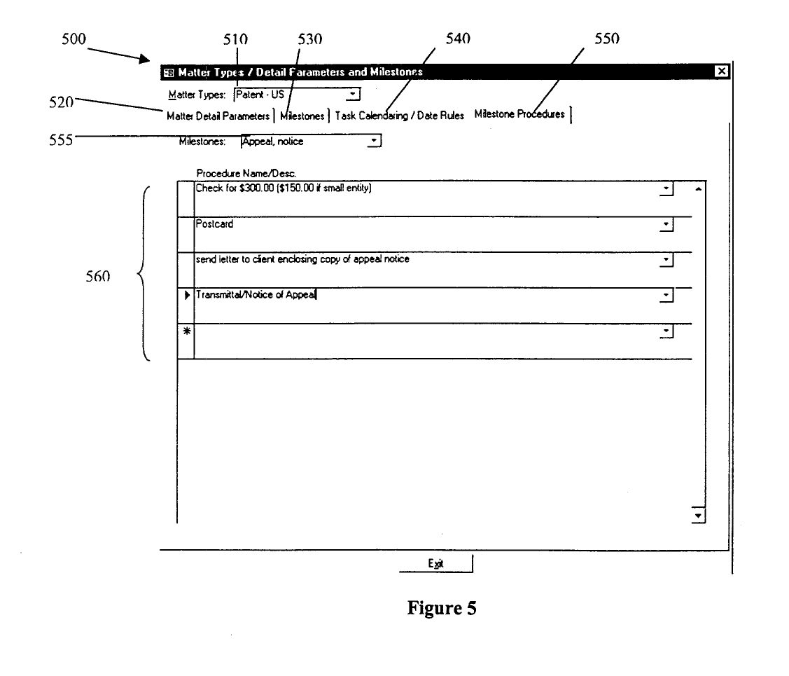

In FIG. 5, is an example of a maintenance and display interface for non-calendar reminders. The interface 500 has a Matter Type area 510, and tabs for Matter Detail Parameters 520, Milestones 530, Task Calendaring/Date Rules 540, and Milestone Procedures 550. Turing to the Procedure Name/Desc. section 560, it is contemplated that users will enter whatever reminder information is appropriate for the particular Matter Type 510 and Milestone 555. In this instance the user defined on-line procedures deal with reminders to the person filing a new patent application, and are relatively limited in both detail and extent. In other instances the on-line procedures may be more or less detailed or extensive.

Differences between the presently described system and previous matter management systems can now be more fully appreciated. Previously known matter management software is extremely poor at providing a rapid overview of the status of a matter. The Timeslips™ program, for example, typically shows a single hour entry per interface, requiring a user to prepare a separate report to visualize all recent hours for a given matter. Other programs may show the last several hours entries, but do not show calendar information at the same time. And to the best of our knowledge no previously known matter management software displays milestone information at all, as the term “milestone” is used herein, let alone showing milestone information on the same interface as hours and calendar information. The closest any system comes is the Patsy™ software, which shows calendar information on the same display as important dates for the type of matter at hand—office action dates for patent filings, section 8 & 15 affidavit dates for trademarks, and so forth.

But simply having fields for various dates is not at all equivalent to the open ended type of milestone information contemplated herein. One clear way of distinguishing the fixed type of date fields in systems such as Patsy™ from the milestone fields contemplated herein is that in preferred embodiments of the present system, users are permitted to set the milestones themselves, not merely enter dates. Another way of distinguishing these different types of systems is that in at least preferred embodiments of presently contemplated software, the milestone fields and related data can be scrolled on a user interface. This allows preferred systems to accommodate more milestones than could realistically be fit onto an interface in a fixed manner. Still another way of distinguishing these different types of systems is that in at least preferred embodiments of presently contemplated software, a user can enter non-date data for each milestone. Thus, for example, in entering a milestone for recordation of an assignment, a user can not only enter a date, but also a reel/frame number. Similarly, in entering a milestone for abandonment of a matter in favor of a continuation, a user can enter the serial number of the continuation. The same can be true for all milestones.

Hours

Referring again to FIG. 1a, section 160 includes hours information. In this particular example there are three rows of hours information, each row including a date 161, an hours description 162, an hours comment 163, an hours designation 164, an adjustment 165, a calculated hours amount 166, a timekeeper designation 167, and a rate code 168.

Date 161 may be limited to the current date or a past date, and in any event it may be advantageous to warn the user if the date is not the current date. Double clicking on the date may bring up a calendar interface (not shown) for ease in selecting a date. The hours description 162 is free-form text, and may be single or multi-lined, where multi-lined descriptions include a vertical slider. The hours comment 163 is preferably for internal use only, and is therefore generally not printed on invoices, client reports, and so forth. The hours designation 164 may be zero or any real number, positive or negative, although negative numbers and those larger than a given threshold may provoke a warning from the system. The adjustment 165 is usually zero, but can also be any real number. The calculated hours amount 166 is merely the hours designation 164 plus the adjustment 165. Thus, if a discount is intended, the user would enter a negative number for the adjustment 165. The timekeeper designation 167 is usually the timekeeper's initials, or some other sort of code. Double clicking on the timekeeper designation 167 may advantageously provoke the system to display a summary of the timekeeper's billings for the day, week, or month. The rate code 168 is some sort of user-defined code, that may be something very simple such as “A”, “B”, “X”, etc., or something more descriptive such as “Normal”, “Discount-1”, “half-price”, etc.

Unlike Time Slips™ and many other popular systems, section 160 is advantageous in that it shows more than one entry for a matter at a time, and additional entries are available through scrolling. The hours shown may also advantageously show entries for all timekeepers, so that a current user can more readily maintain proper consistency in group projects.

Non-Calendar Timer

Referring yet again to FIG. 1a, the timer field 186 is used to remind the user that this matter (docket no. 120) may be overlooked if not examined within the timer period. Here, the timer field 186 happens to contain the data, 12 days. In preferred embodiments the timer field 186 displays a countdown of days, months or some other time period for the most current milestone in the milestone area 150. In such embodiments, for example, the timer for a milestone of a first matter may be set to 30 days, and the timer for a milestone of a second matter may be set to 90 days. One week after setting such timers, the first matter would display 23 days in the timer field 186 while the second matter would display 83 days in the timer field 186.

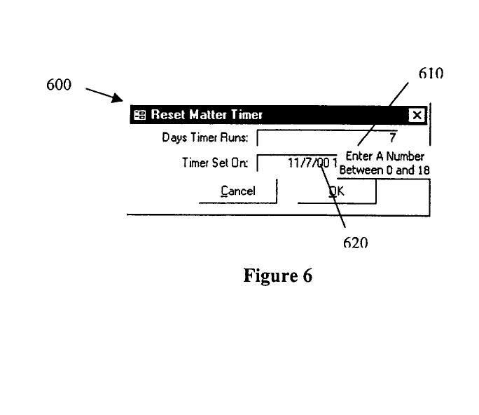

FIG. 6 depicts an exemplary interface 600 for changing the timer for a given matter. The user (not shown) may enter a number in the Days Timer Runs 610 area. The number entered in the Days Timer Runs 610 field is displayed on a matter screen for the purpose of reminding the user to look at the matter. The number decrements by 1 each day reminding the user of the impending date. In a particular embodiment the matter specific timer be set automatically upon the selection of a milestone, but such a timer may be overridden by the user.

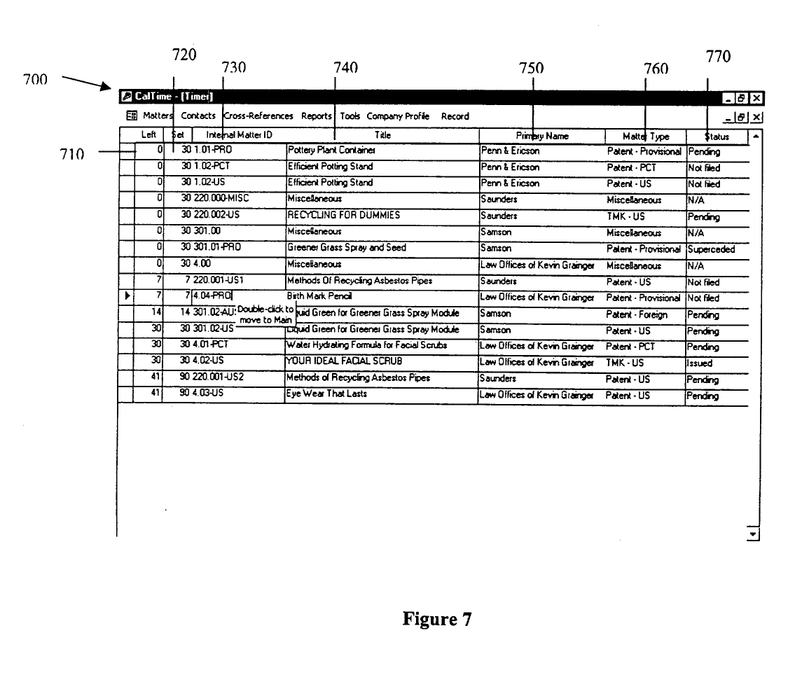

In FIG. 7 a timer summary 700 lists matter specific timers sorted by remaining time. While any suitable data may be included, this particular example shows time remaining 710, time set 720, matter docket number 730, title 740, primary name 750, matter type 760, and status 770. In this manner a user can easily spot matters where the timer has gone down to zero, and which may therefore need attention. Another aspect of count-down timers that has been found to be useful is an upper limit on the number of days to which a timer can be reset. It is contemplated that maximums can be set at any suitable value, such as ≦500 days, 365 days, 180 days, 6 months, 3 months, and so forth. The presently preferred maximum timer setting is 180 days.

Matter specific timers may be reset from time to time, either automatically or manually. In preferred embodiments, the manual timer reset interface 600 is accessed by double clicking on the timer field 186. Automatic timer reset may also be triggered by the user selecting a milestone from a milestone list, where different milestones most likely have different timer resets. Thus, a milestone of opening a new file may have a timer reset of 14 days, while a milestone of receiving a foreign filing license and filing receipt from the patent office may have a timer reset of 180 days. Some milestones may not have any timer reset.

Timer resets can be implemented in any suitable manner. In a preferred embodiment the timer for each matter is stored using two fields, a timer reset date and a timer reset days.

The system compares these values against the present date, calculates the number of days left, and displays that calculated number in field 186. Also, in the preferred example milestone resets are stored separately, one for each of the milestones. When a user selects a milestone from the milestones list, the system updates the timer reset date to the current date, and replaces the timer reset days with the default number of days that is associated with the milestone.

It will be appreciated that the timers contemplated herein are matter specific timers, not the traditional timekeeping minutes or hours timers found in other systems. A major distinction is that matter specific timers keep track of duration since the occurrence of an event related to the matter as a whole, while timekeeping timers keep track of the time that a timekeeper (attorney, paralegal, etc) is working on a matter. A related consequence is that matter specific timers generally keep track of days, weeks or months, while timekeeping timers generally keep track of minutes or hours.

Matter timers are preferably count-down timers as described above, although count-up timers are also contemplated in which a field such as field 186 would show the number of days (months or some other time period) since the timer was reset. For example, a count-up timer that was reset to zero on a Monday, may show 4 days on Friday, and 6 days on the following Monday. Similarly, a count-up timer set to 30 on the first of a month may show 60 or 61 a month later. A summary listing (not shown) can also be employed with count-up timers, but would presumably be used in reverse, with a user working down from matters having the highest timer settings, resetting the timers on such matters to zero, or some higher value.

Calendar

Referring yet again to FIG. 1a, the calendar section 170 generally includes a calendar date 171, a calendar description 172, a calendar comment 173, an urgency designation 174, a status 175, a primary responsible timekeeper 176, and a secondary responsible timekeeper 177. As with both milestones section 150 and the hours section 160, the calendar section 170 has three rows in this example, although the available space could readily have been parsed out in some other manner.

The calendar date 171 is similar to that for milestones and hours. It preferably defaults to the current date, and double clicking on the field triggers presentation of a monthly calendar to assist in selecting a date. The calendar description 172 is free form text, and may be single or multi-lined, where multi-lined descriptions include a vertical slider. The calendar comment 173 is for internal use, and is not printed on reports intended for clients. The urgency designation 174 is a user-defined code, and may advantageously include “Drop Dead”, “Deadline”, “Warning”, and “Reminder”. The status 175 line is also a user-defined code, and may advantageously include “completed”, “missed”, “recalendared”, “entry error”, and the like. In preferred embodiments Entry of data in the field does not delete the record, but merely hides it from view. This keeps the entry for archival purposes, but maintains the calendar section free from displaying old items. The primary responsible timekeeper 176 and secondary responsible timekeeper 177 fields contain the same timekeeper codes used in conjunction with the hours section 160.

Matter Details

There is any number of specialized pieces of information that users may want to associate with a matter. The information typically differs substantially forom matter type to matter type, and often differs somewhat even among different matters having the same matter type. For example, a US trademark matter may advantageously be associated with information on the international class, the first use date, the first use in commerce date, a description of goods and services, the legal form of the registrant, and the registration number. In contrast, a US patent matter may advantageously be associated with information regarding small or large entity. abstract current claims, current independent claims, current drawings, and patent number. Such information could be maintained in memo fields, or in generic fields set up to handle data not stored elsewhere. But both of those solutions are unsatisfactory for many reasons, including the difficulty of searching and sorting the information. Both solutions also have the drawback that they tend to result in users'failing to notice that desired data is missing.

A similar situation exists for contacts. There are often ten or more people or companies related to particular matter, in all sorts of different capacities. In patent matters, for example, a user may want to associate with the matter four or five named inventors, a primary contact, several secondary contacts, a billing contact, one or more assignees, several potential licensees, one or more actual licensees, previous counsel, third party consultants and vendors, responsible partner, responsible attorney, and responsible paralegal. The complexity can be very great indeed because a single person could be associated with the matter in different capacities, and from different addresses. For example, a user may want to store a pointer to a person's home address in the capacity of inventor, and a pointer to the same person's address at work for that person's capacity as a consultant. This can be very important in cases where a single person works for several companies, and different matters are related to the inventor's work at the different companies.

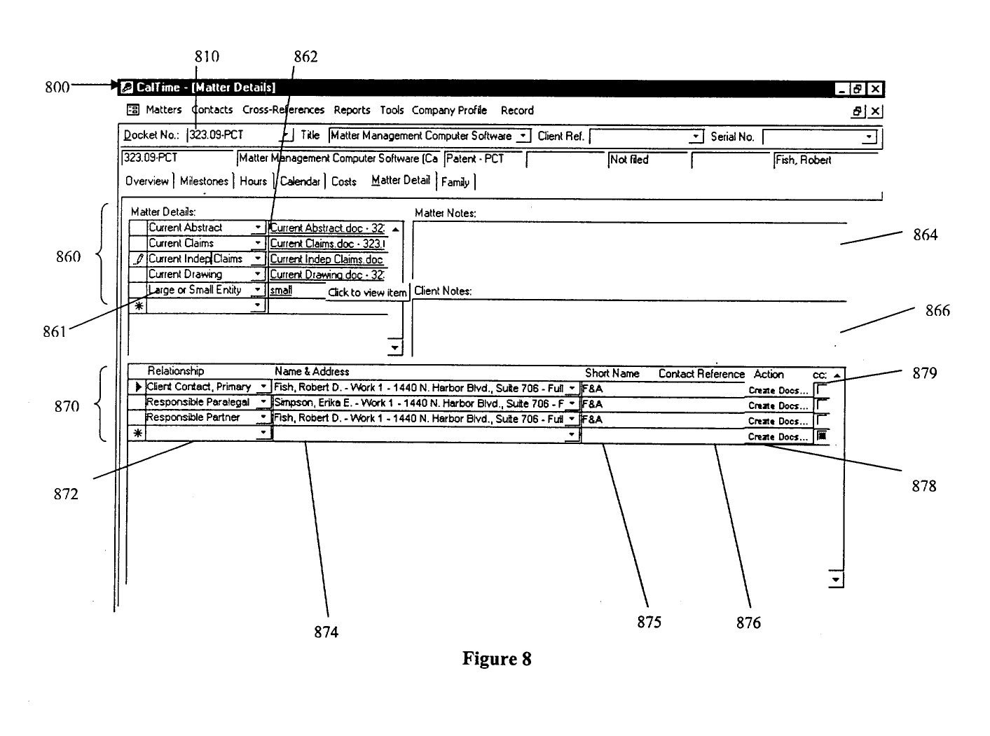

In FIG. 8 a preferred matter details interface 800 allows users to enter any practical number of matter details 860, as well as any practical number of contacts 870, all of which can vary enormously from matter to matter. This is accomplished through the use of identifier/value pairs, in much the same manner that milestones, address specific information and contact specific information are stored. The interface generally includes a matter detail section 860, a matter notes field 864, a client notes filed 966, and a matter contacts section 870.

The matter details section 860 has a matter detail identifier column 861 and a matter detail values column 862, related as identifier/value pairs in a manner described elsewhere herein. The matter detail identifier column 861 contains user-defined identifiers, which can be listed and scrolled. Preferably, the matter detail identifiers 861 that are listed are only a subset of all entered matter detail identifiers entered into the system, as appropriate for the matter type of the current matter. The matter detail column 861 is either free-form text, or a pointer to a word processing, spreadsheet, image, or other document.

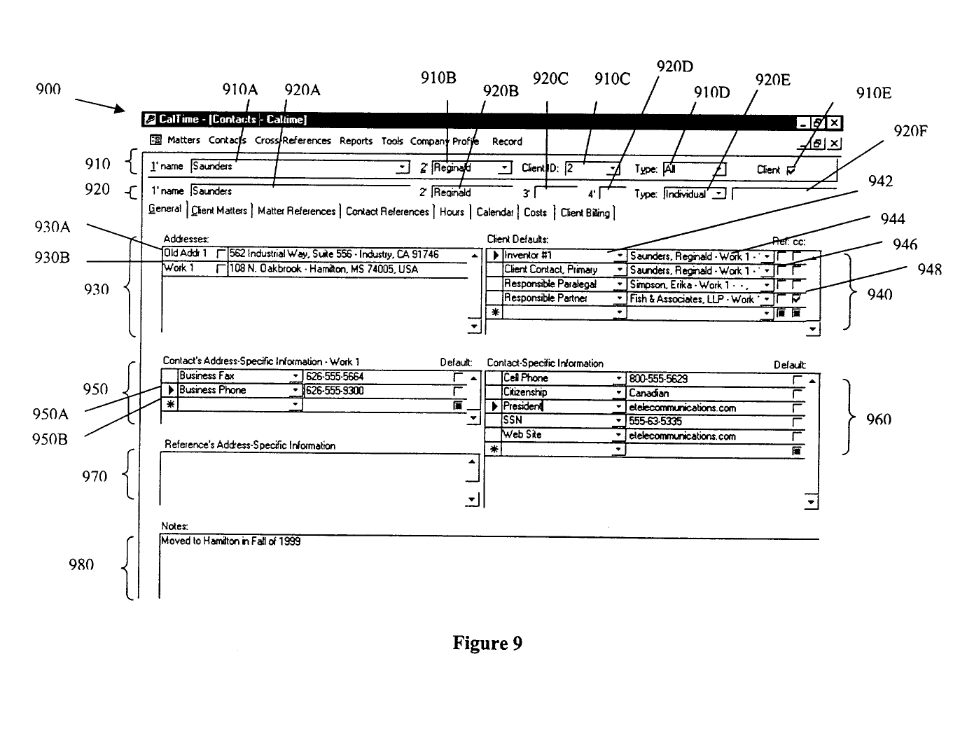

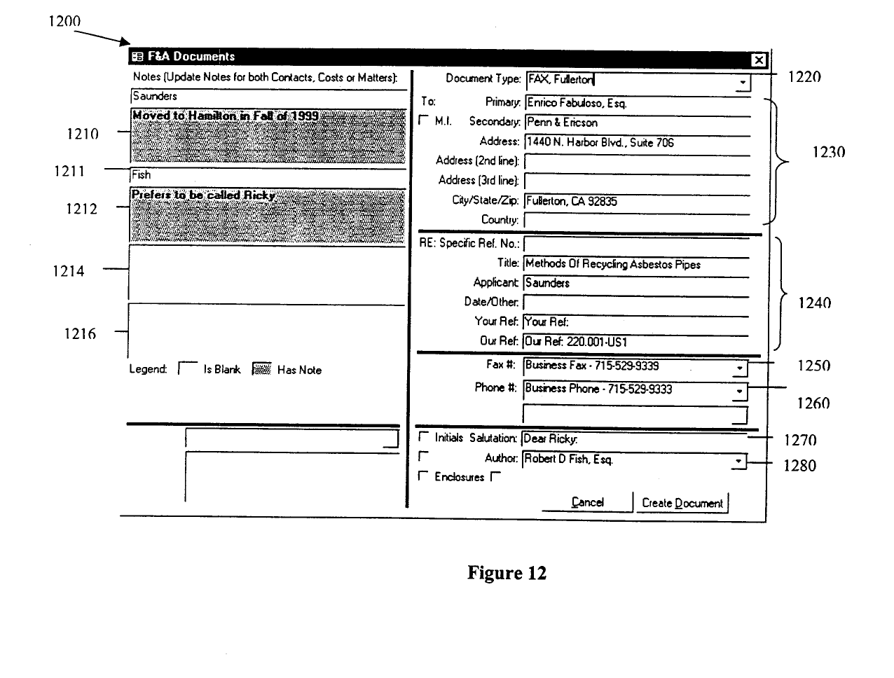

The matter contacts section 870 has six columns—a contacts relationship column 872, a contact name and address column 874, a short name column 875, a reference column 876, a create documents column 878, and a cc column 879. The contacts relationship column 872 contains user-defined reference identifiers that can advantageously be added to, and maintained by users in a manner appropriate for their particular circumstances. Thus, a patent law firm may choose to include relationship identifiers for inventors, assignees, patent and trademark examiners, foreign associates, potential licensees, potential investors, previous counsel, storage services, searching services, etc. Available matter contact relationships are preferably displayed and selected using a drop-down listing. The contact and address column 874 preferably echoes contacts and address information entered elsewhere, such as using the interface of FIG. 9. The reference column 876 is employed to store whatever information is appropriate for the matter contact relationship. Thus, for foreign associates, prior counsel, inventors, and so forth, the reference information may be the contact's docket number for the current matter. For assignees, appropriate reference information may be the reel/frame number. For a storage service appropriate reference information may be a box number. Preferred systems provide for the use of the literal “Client Reference” as an ersatz reference, which is substituted in documents by reference the corresponding client reference number for this particular matter. The create documents column 878 contains a button in each row that triggers display of a document creation interface (see FIG. 12). The cc column 879 includes check boxes for selecting whether the indicated contact should receive copies of documents sent out regarding this matter. If the box is checked, the system automatically adds a cc to the indicated contact whenever a document is created for another contact for this matter through the document creation system shown in FIG. 12.

Contact Selection

FIG. 9 depicts a contacts interface 900 generally including a contacts selection section 910, a contacts identifier section 920, an addresses section 930, a default contacts section 940, a contacts address specific information section 950, a contact's specific information section 960, a reference's specific information 970, and a contact memo section 980. The contacts interface scrollably displays at least one of the identifier/value pairs for both the contact specific data and the address-specific data.

The contacts selection section includes fields for selecting a contact by primary name (i.e., last name for a person or company name for a company) 910A, first name 910B (which of course does not exist for a company), client ID number 910C (for contacts that are also clients), and contact type 910D (such as individual, company, government agency, court, etc).

Contacts identifier section 920 includes contact identification information, including the contact's primary name 920A, secondary name 920B, middle name or initial 920C, title or other suffix 920D, contact type 920E, contact salutation 920F (greeting to be used in letters e.g., “Dear Sir:”), and a check box 910E distinguishing between client and non-client contacts. In the case of individuals, the 920A-920D would usually correspond to last name, first name, middle name or initial, and suffix, respectively.

The address section 930 allows users to associate any practical number of addresses with a given contact. This flexibility has long been desired since a given contact may work or have previously worked at several different companies, and may live or have previously lived at several different residences. In this example the software also provides links to addresses of other entities (a referenced company or individual) so that changing the address of a single entity (such as a business) would automatically change the addresses for numerous contacts (such as the work address of related employees of that business). It is preferred that each line 930A-930B displays a different address for the contact, even if the data on the line scrolls off the visible field.

The default contacts section 940 includes columns for default relationship 942, default contact name and address 944, default contact reference 946, and cc check box 948. The default contacts section 940 is only active for contacts that are also clients (i.e., client check box 910E). In those cases, the default contacts section 940 is used to initially populate the matter contacts section 870. The default relationship 942 is preferably selected from a drop down list of user defined relationships, which is preferably the same drop-down list used in conjunction with the contacts relationship column 872 of FIG. 8. The default contact name and address 944 is selected from a drop-down list of available contacts and addresses, which is preferably the same drop-down list used in conjunction with the contact and address column 874 of FIG. 8. The default contact reference 946 is a user-defined text field. The use of “Client Reference” as an ersatz reference is permitted.

The address specific data section 950 displays data stored using the identifier/value concept for one or more of the address lines 950A-950B. There, appropriate identifiers may be telephone numbers, fax numbers, title (president, etc. where the address is a link to a company), receptionist's name, address specific E-mail address, and so forth. The contact specific data section 960 displays data stored using the same identifier/value concept. Here, however, appropriate identifiers may be the name of a spouse, child, or co-worker, a cell phone number, an E-mail address, a social security number, a birth date, citizenship, and so forth. The set of address specific information displayed in address specific section 950 depends, of course, on the particular address clicked on in the address section 930, and if no particular address is clicked on, then the first address is used as a default. Those skilled in the art will be able to extrapolate many additional identifiers, and will appreciate the advantages derived from users being able to define and enter whatever identifiers are appropriate for their particular businesses. Just as a simple example, most companies would not be interested in keeping track of citizenship of contacts, especially employee contacts, but a patent law firm needs that information available in one way or another to file patent applications. Those skilled in the art will also appreciate that as described elsewhere herein, use of the identifier/value concept allows the system to make all of the appropriate identifiers available to a user in a drop down list, but then only display those identifiers and values corresponding to the matter type of the currently selected matter.

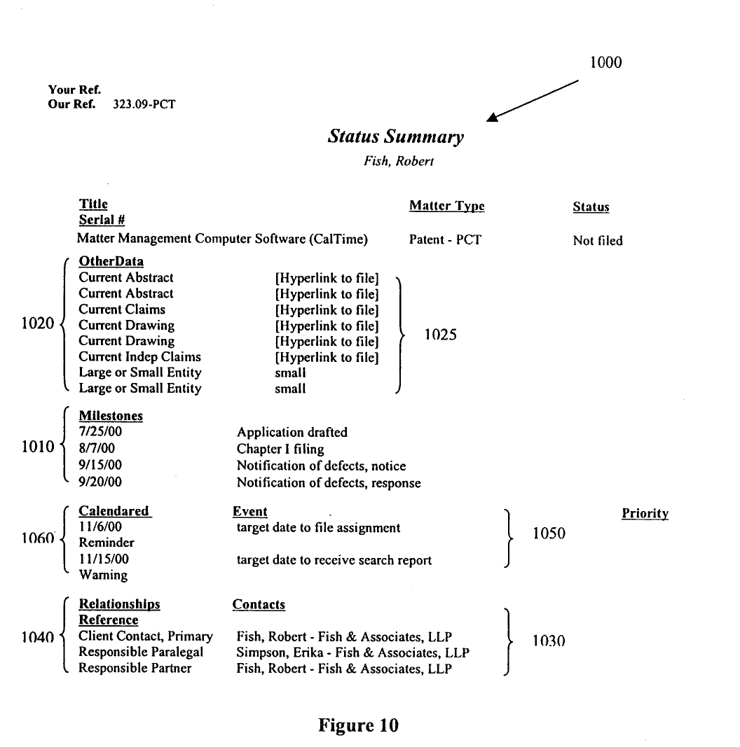

FIG. 10 is a matter status summary report 1000 depicting a preferred arrangement of milestone 1010, matter detail 1020, matter contacts 1030 with associated contact relationships 1040, and an area for calendared events 1050 with an associated date 1160. This report uses identifier/value pairs and hyperlinks 1025 to create a useful and interactive summary of a matter.

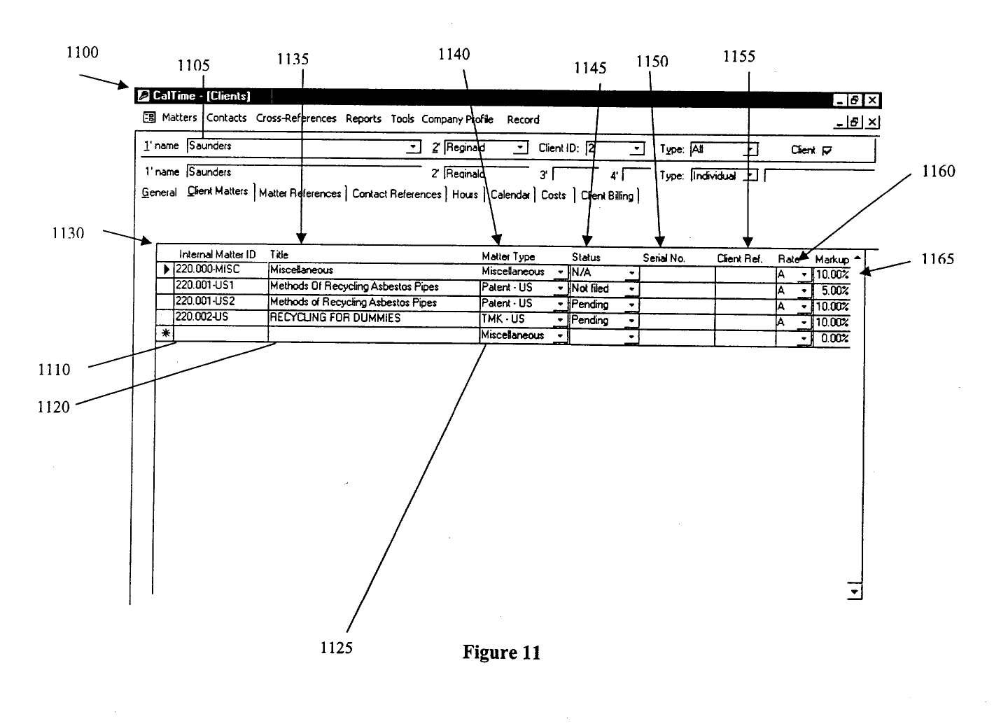

FIG. 11 is an interface 1100 for creating records for a new matter number 1110 and associated matter title 1120 in the database, and correlating matter type 1125 and other information with the new matters 1110. Each matter 1110 and its correlated type 1125 and other information are linked to a particular contact 1105. Interface 1100 generally contains columns for matter number 1130, matter title 1135, matter type 1140, matter status 1145, serial number 1150,client reference 1155, matter rate code 1160, and a matter markup 1165. Interface 1100 may be useful for a user who receives a phone call from a contact 1105, and needs to quickly find the matter numbers 1130, the matter statuses 1145, and other information associated to the contact 1105.

FIG. 12 generally depicts a document creation interface 1200 having a first contact notes field 1210, a specific contact field 1211, a second contact notes field 1212, a cost notes field 1214, a matter notes field 1216, a document type selector 1220, recipient information fields 1230, matter reference fields 1240, fax number 1250, phone number 1260, salutation 1270 and author 1280. The document creation interface is displayed in response to a selection of create documents 878.

The first contact notes field 1210 displays the contact notes associated with the client. The contact notes field 1212 displays the notes that may have been entered for the chosen contact 980. Cost notes field 1214 displays cost notes that are associated with the chosen contact 980. Matter notes field 1216 contains the notes that have been entered in field 864, and associated to the matter 810 of FIG. 8. Displaying all of these various memos is very helpful in providing appropriate reminders to the user when creating documents.

The document type selector 1220 allows a user to select from a drop-down list of predefined document types, including fax, e-mail, letter, and-so forth. The choices correspond to templates created by the user, and which are populated with data from the recipient information fields 1230, and the matter reference fields 1240. The recipient information fields 1230 are themselves populated from the corresponding contacts fields of FIG. 9.

E-mail addresses, fax, and phone numbers are special cases in that they are taken from the recipient's address specific data section 950. If one or both of the numbers are not found, then the system looks to the contact specific information section 960 for the recipient. If one or both of the numbers are still not found, then the system looks to the address specific information section 950 for a corresponding referenced company or individual, and finally to the contact specific information for the referenced company or individual.

Field 1240 is defaulted to the information contained in the matter identifiers 130A-130G for the current matter. If, however, they are modified by the user, the system asks if the user wants to keep the modifications for the future. If so, the new values are used as defaults in the future, without affecting the data stored as matter identifiers 130A-130G for the current matter. The author field 1280 has a drop-down menu, allowing the user to select from names of timekeepers, which are advantageously the same timekeepers designated in fields 167, 176, and 177.

Identifier/Value Concept

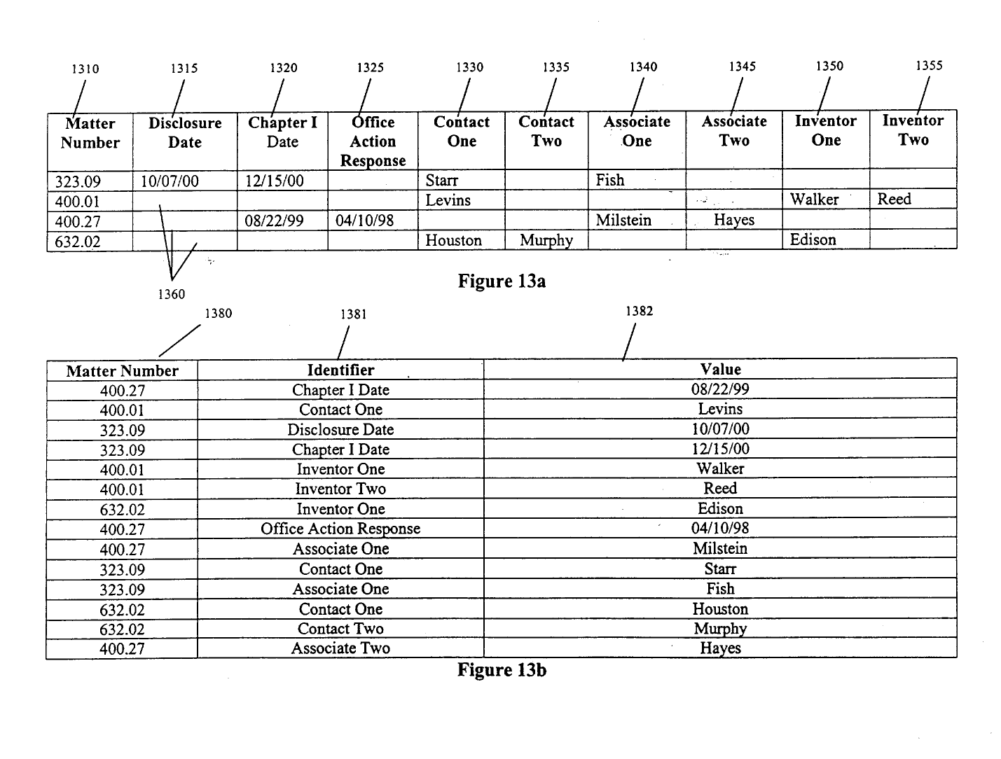

FIG. 13a is a representation of a data table for a previous calendaring system that has pre-defined fields shown in columns 1315-1355. In such systems each column represents a field for storing a particular item of information, such as “Disclosure Date” in column 1315, or Chapter I filing date in column 1320. The fields of any given data table are, of course, designed to satisfy at least a majority of demands for storing data for a particular type of matter (eg, patents). Since different matters types (eg, copyright, trademark, immigration) would require different data items, each different matter type would typically require a different table with different field names.

The rows in FIG. 13a represent data for individual matters. In this particular example, the matter numbers are stored in the first data field, column 1310. One can immediately appreciate that this manner of storing data is very wasteful. For matters that don't use “Disclosure Date”, for example, there will be blank data 1360 stored in the database. The same would be true for any of the other user-defined fields 1320-1355.

It turns out that a user in a patent firm needs hundreds of data fields. Just for storing patent information one may well need to designate 8 or more inventors, 30 or more dates, 50 or more contact people, and 20 or more miscellaneous descriptions for a particular matter. Using the previous type of fixed field data storage, this would require 108 fields for each matter record, and of those perhaps 80% of the cells would be blank because the average matter may use only 22-25 fields.

Not only does designation of a pre-defined field waste disk space, it also wastes real estate on the interface (computer display) by unnecessarily displaying blank fields to the user. The inefficiency is so great that many known software packages have distinct interfaces for each different type of matter. Otherwise there is no realistic way of displaying hundreds of different fields on the same interface.

Some previous systems try to accommodate the differing needs of users by providing a dozen or more user-defined fields. But such fields are still pre-determined fields, and waste space in both the table and the interface as discussed above. Moreover, a user must keep track for himself how the various fields are used. For example, is user-defined field number 3 used for the name of an extra inventor, or for some special date. As a result, users often store inconsistent data in the same user-defined field across different matters.

As used herein “identifier/value” refers to storage of data in pairs, where one part of the pair stores all identifier (or pointer to an identifier), and the other part of the pair stores data related to the corresponding identifier. In that manner each value is stored along with an identifier as a new record, rather than using the identifier as a field name, and storing the values for multiple matters in rows of a table relating to that field. There are at least two main advantages. First, each matter can have any number of identifier/value pairs. Thus, a patent matter can have 25 or more inventors associated, rather than being limited to a fixed number (such as 5 or 6) inventors for which there are pre-defined fields. Second, each matter only takes up as much data storage space as it actually utilizes.

In FIG. 13b, a sample data table has three fixed fields, designated by columns 1380, 1381, and 1382. Field 1380 stores matter number, field 1381 stores identifiers, and field 1382 stores corresponding values. The value 1381 field may store any type of data including text data, which may include ordinary text such as a person's name, numbers, dates, uniform resource locators (URL), hyper-links, and pointers to images. As can be readily appreciated the field names of a previous data table such as that shown in FIG. 13a can be used as identifier data in the identifier field 1381 of the data table of FIG. 13b.

An exemplary use of identifier/values is shown in FIG. 1a, section 150, where the identifiers include “Office action, response”, “Notice of allowance”, “Family filing, divisional”, and the corresponding data include “10-Apr-98”, “09-Jun-98”, and “24-Jul-98”. Another exemplary use is shown in FIG. 8, section 860, where the identifiers are “Current Abstract”, “Current Claims”, “Current Indep Claims”, etc, and the corresponding values are pointers to various files. Still another exemplary use is shown in FIG. 8, section 870, where the identifiers are “Client Contac, Primary”, “Responsible Paralegal”, “Responsible Partner”, etc, and the corresponding values are pointers to various contact records. The same use is made of contact relationship type identifiers in FIG. 9, section 940. Still other exemplary uses are shown in FIG. 9, sections 950 and 960, where the identifiers are such items as “Business Fax” “Business Phone”, “Cell Phone”, “Citizenship”. “President”, etc. Still another exemplary use is shown in FIG. 9, section 930, in which identifiers are “Old Addr 1”, “Work 1”, etc, and the values are the actual data of the addresses. Even office procedures can be stores as identifier/value pairs, as can be seen in FIG. 5. In each of these instances there are dozens or even hundreds of identifier choices, but only those choices selected for each matter are shown on the user interface, and only those choices actually utilized for each matter take up space in the database.

As briefly discussed above, one limitation that may be avoided through the use of identifier/value pairs is an otherwise rather strict limit on the number of fields that can be included in a system. In previous systems, for example, a patent user may be limited to storing names for only 5 or 6 inventors. Yes, most matters have less than 5 or 6 inventors, but there are also matters with 15 inventors. To allocate space for 15 inventors is very wasteful for almost all of the matters. And even then, what happens when a matter has 16 inventors? The previous systems have no good way to resolve that issue.

Similarly, with respect to contact information, many systems store phone and fax numbers, title, and so forth. But it is sometimes advantageous to store data on other types of information, such as inclusion on a Christmas list, social security number, reference number, account code, password, help line code or number, and so forth. There may indeed be hundreds of such identifiers to choose from, and still each contact will only utilize display space and storage space for the identifiers actually used. Additionally, because identifier/values can be displayed using drop-down or scrollable lists, display real estate is not a limiting factor even if a particular contact uses dozens of identifiers.

A related advantage is that by displaying the identifier with respect to each value, a higher degree of clarity is achieved in the display. A user looking at a crowded display showing dozens of pre-defined fields may not be completely certain what the values in the display fields relate to. However, the use of identifier/value pairs improves the display efficiency to such a degree that each identifier can be displayed in a clear manner. It is even contemplated that different users may alter the display order of the various identifiers, such that those of greater importance tend to be near the top of any list.

Still another contemplated benefit of using identifier/values is that a relatively high degree of storage and display efficiency is achieved because there are generally no blank fields on the storage device or on the display. Thus, the user in the patent firm described in the previous paragraph would not have 80% blank data in his records. Blank fields on a storage device are inefficient because they take up space without actually storing a value, and blank fields on the interface are inefficient because there is a limited amount of space on an interface with which to display fields.

Thus, specific embodiments and applications of matter management systems have been disclosed. It should be apparent, however, to those skilled in the art that many more modifications besides those already described are possible without departing from the inventive concepts herein. The inventive subject matter, therefore, is not to be restricted except in the spirit of the appended claims.

What is claimed is:

1. A matter management system at least partially stored on a computer readable medium comprising at least one feature selected from the group consisting of: (a) a single display that shows matter identification information, a plurality of milestones, a plurality of hourly billing descriptions, and a plurality of calendared items; (b) a user-defined on-line procedures mechanism accessed by selection of a milestone of the plurality of milestones; (c) a matter specific timer based reminder mechanism; and (d) a plurality of identifier/value pairs for storing data.

2. The system of claim 1 wherein the feature comprises the single display that simultaneously shows a plurality of matter identification information data items, the plurality of milestones, the plurality of hourly billing descriptions, and the plurality of calendared items.

3. The system of claim 2 wherein the single display simultaneous shows at least three of the plurality of milestones, at least three of the plurality of hourly billing descriptions, and at least three of the plurality of calendared items.

4. The system of claim 1 wherein the feature comprises the user-defined on-line procedures mechanism accessed by selection of a milestone of the plurality of milestones.

5. The system of claim 4 wherein the feature comprises the matter specific timer based reminder mechanism.

6. The system of claim 5 wherein the matter specific timer is set automatically upon the selection of a milestone of the plurality of milestones.

7. The system of claim 1 wherein the feature comprises the plurality of a plurality of identifier/value pairs for storing data.

8. The system of claim 7 further comprising a user interface that scrollably displays at least one of the identifier/value pairs for the milestones, contact specific information, address specific information, and matter contact relationships.

9. The system of claim 7 further comprising a user interface that scrollably displays at least two of the identifier/value pairs for the milestones, contact specific information, address specific information, and matter contact relationships.

10. The system of claim 1 comprising at least two of the features in the group.

11. The system of claim 1 comprising at least three of the features in the group.

12. A method of managing information in a computer implemented matter management system, comprising:
storing a plurality of user-defined data identifiers on a database;
providing a user interface with a scrollable listing of the identifiers;
selecting a subset of the data identifiers for a particular matter;
entering and associating an item of text data with at least one data identifier of the selected subset; and
interactively displaying in a single display a plurality of identification information data items for the matter, the at least one data identifier, and its associated text data.

13. The method of claim 12 wherein the data identifiers comprise milestones.

14. The method of claim 12 wherein the data identifiers comprise office procedures.

15. The method of claim 12 wherein the data identifiers comprise matter details.

16. The method of claim 12 wherein the data identifiers comprise contact relationships.

17. The method of claim 12 wherein the data identifiers comprise contact specific or address specific information.

18. A matter management system at least partially stored on a computer readable medium comprising:
a first designation interface that provides for designation of a matter as having a matter type selected from a plurality of matter types;
a second designation interface that provides for designation of a plurality of milestones for the matter type;
a selection interface that provides for selection of a proper subset of the plurality of milestones as being appropriate for the matter, thereby defining a non-null subset of non-selected members of the plurality of milestones; and
an interactive display that displays in a single display a plurality of identification information data items for the matter, and at least one of the selected subset of milestones without listing all of the non-selected members.

19. The matter management system of claim 18 wherein the interactive display displays all of the selected subset of milestones.

20. The matter management system of claim 18 wherein the interactive display displays none of the non-selected members.

21. A matter management system having both an auto-calendaring function and a matter timer.
